(19) United States
(12) Patent Application Publication
(10) Pub. No.: US 2021/0081906 A1
(43) Pub. Date: Mar. 18, 2021

(54) INFORMATION NOTIFICATION APPARATUS

(71) Applicant: HONDA MOTOR CO., LTD., Tokyo (JP)

(72) Inventors: Takamichi SHIMADA, Tokyo (JP); Koki FUJISAWA, Tokyo (JP)

(21) Appl. No.: 17/018,714

(22) Filed: Sep. 11, 2020

(30) Foreign Application Priority Data
Sep. 18, 2019 (JP) 2019-169423

(51) Int. Cl. G06Q 10/00; G06Q 30/06; G06Q 30/02

(52) U.S. Cl. CPC G06Q 10/20; G06Q 30/0207; G06Q 30/0645

(57) ABSTRACT

An information notification apparatus including a microprocessor and a memory. The microprocessor and the memory are configured to perform acquiring a first data on an image of an appearance of a shared vehicle used in a car sharing service in which a vehicle is rented without human intervention, when the shared vehicle is returned, acquiring a second data on an image of an interior of the shared vehicle when the shared vehicle is returned, determining a degree of dirt of the shared vehicle based on the first data and the second data, determining a presence or absence of an object left in the shared vehicle by a user of the shared vehicle based on the second data; and transmitting an information on the degree of dirt and an information on the presence or absence of the object to a manager terminal of a manager of the shared vehicle.

### CROSS-REFERENCE TO RELATED APPLICATION

This application is based upon and claims the benefit of priority from Japanese Patent Application No. 2019-169423 filed on Sep. 18, 2019, the content of which is incorporated herein by reference.

### BACKGROUND OF THE INVENTION

### Field of the Invention

This invention relates to an information notification apparatus, a car sharing system and an information notification method for notifying information of dirt of the vehicle and the like.

### Description of the Related Art

Recently, a car sharing service using a shared vehicle parked in an unmanned dedicated parking lot has become popular. In such a car sharing service, since the location for returning the shared vehicle is also an unmanned dedicated parking lot, it is difficult to manage the shared vehicle after use. To cope with this problem, a technique of automatically checking the presence or absence of an object left in the shared vehicle by a user is disclosed (for example, disclosed in Japanese Patent Laid-Open No. 2013-191053).

Incidentally, in the above-described car sharing service, in order to make the user use a vehicle comfortably, it is necessary to manage the condition of the vehicle, for example, dirt of the vehicle. Regarding dirt of the vehicle, a cleaning of the vehicle is performed regularly in the car sharing service. However, depending on the timing, the user may be asked to use a dirty vehicle, which is undesirable. On the other hand, increasing the number of periodic cleaning increases the cost.

### SUMMARY OF THE INVENTION

An aspect of the present invention is an information notification apparatus. The information notification apparatus includes a microprocessor and a memory coupled to the microprocessor. The microprocessor and the memory are configured to perform acquiring a first data on an image of an appearance of a shared vehicle used in a car sharing service in which a vehicle is rented without human intervention, when the shared vehicle is returned, acquiring a second data on an image of an interior of the shared vehicle when the shared vehicle is returned, determining a degree of dirt of the shared vehicle based on the first data and the second data, determining a presence or absence of an object left in the shared vehicle by a user of the shared vehicle based on the second data; and transmitting an information on the degree of dirt and an information on the presence or absence of the object to a manager terminal of a manager of the shared vehicle.

Another aspect of the present invention is a car sharing system. The car sharing system includes the above information notification apparatus, a manager terminal of a manager who manages a shared vehicle in a car sharing service in which a vehicle is rented without human intervention, being capable of communicating with the information notification apparatus, a user terminal of a user who uses the car sharing service, being capable of communicating with the information notification apparatus; and a vehicle on which a terminal being capable of communicating with the information notification apparatus is mounted.

Another aspect of the present invention is an information notification method. The information notification method includes acquiring a first data on an image of an appearance of a shared vehicle used in a car sharing service in which a vehicle is rented without human intervention, when the shared vehicle is returned, acquiring a second data on an image of an interior of the shared vehicle when the shared vehicle is returned, determining a degree of dirt of the shared vehicle based on the first data and the second data, determining a presence or absence of an object left in the shared vehicle by a user of the shared vehicle based on the second data; and transmitting an information on the degree of dirt and an information on the presence or absence of the object to a manager terminal of a manager of the shared vehicle.

### BRIEF DESCRIPTION OF THE DRAWINGS

The objects, features, and advantages of the present invention will become clearer from the following description of embodiments in relation to the attached drawings, in which:

FIG. 1 is a schematic configuration diagram of a car sharing system according to an embodiment of the present invention;

FIG. 2 is a diagram showing parking lot cameras installed in unmanned dedicated parking lot used in the car sharing system shown in FIG. 1;

FIG. 3 is a block diagram showing a configuration of a main component of the car sharing system shown in FIG. 1;

FIG. 4 is a block diagram showing a configuration of a main component of the server apparatus shown in FIG. 1; and

FIG. 5 is a flowchart showing an example of a vehicle status notification process executed by processing unit of the server apparatus of FIG. 3.

### DETAILED DESCRIPTION OF THE INVENTION

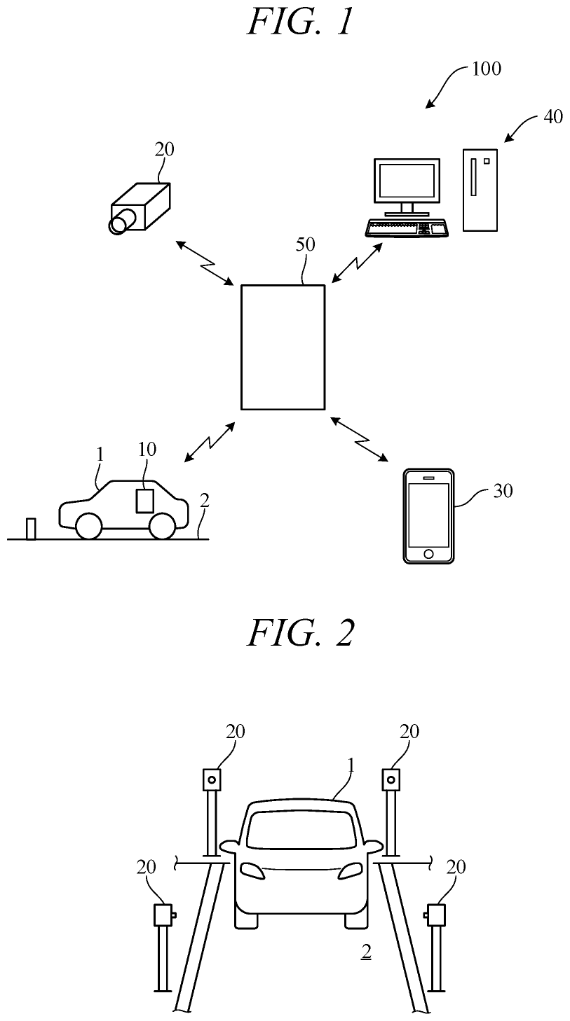

Hereinafter, an embodiment of the present invention is explained with reference to FIGS. 1 to 5. The information notification apparatus according to an embodiment of the present invention is applied to a vehicle owned a business entity providing a vehicle rental service (hereinafter, referred to as a car sharing business entity).

FIG. 1 is a schematic configuration diagram of a car sharing system 100 according to an embodiment of the present invention. As shown in FIG. 1, the car sharing system 100 includes an on-vehicle terminal 10 mounted on the shared vehicle 1, a parking lot camera 20 (imaging apparatus) disposed in an unmanned dedicated parking lot 2 where the shared vehicle 1 is parked, a user terminal 30 of a user using the car sharing service, a manager terminal 40 of a manager who belongs to the car sharing business entity and manages the shared vehicle 1, and a server apparatus 50 of the car sharing business entity. In the car sharing system 100 according to the present embodiment, the information notification apparatus is mainly configured by the server apparatus 50.

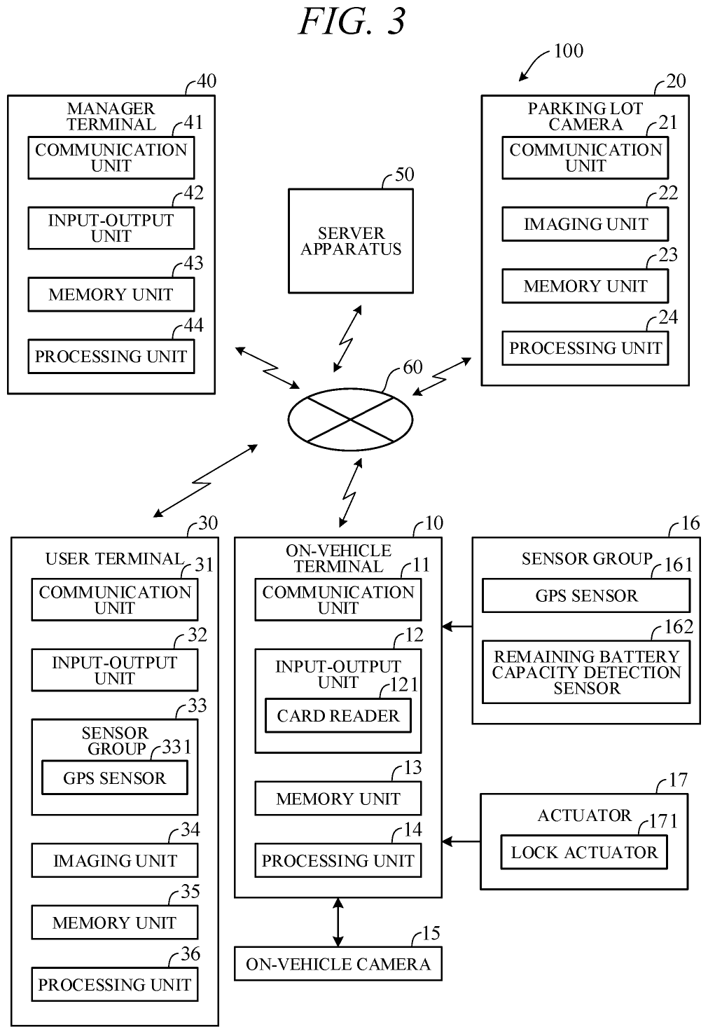

The on-vehicle terminal 10, the parking lot camera 20, the user terminal 30, and the manager terminal 40 are configured to be able to communicate with server apparatus 50 by wireless communication. For the sake of convenience, a single shared vehicle 1 and a single user terminal 30 are shown in FIG. 1, but a plurality of shared vehicles 1 and a plurality of users are registered in the car sharing service. Each user terminal 30 of each user and each on-vehicle terminal 10 mounted on each shared vehicle 1 are configured to be able to communicate with server apparatus 50. Similarly, a single parking lot camera 20 is shown in FIG. 1, but a plurality of parking lot cameras 20 is disposed in the dedicated parking lot 2. FIG. 2 shows parking lot cameras 20 installed in the unmanned dedicated parking lot 2 used in the car sharing system 100 of FIG. 1. In an example shown in FIG. 2, the parking lot cameras 20 are installed on the right front, left front, right rear, and left rear of the shared vehicle 1, respectively, so that the images of the appearance of the shared vehicle 1 can be captured.

The shared vehicle 1 used for the car sharing service is a vehicle of which necessary information is registered in advance in the car sharing business entity, and the registered information is stored in the server apparatus 50 (a vehicle database 531 to be described later). Similarly, a user who uses the car sharing service is a person of which necessary information is registered in advance in a business entity that conducts the car sharing business, and the registered information is stored in the server apparatus 50 (a user database 533 to be described later).

The dedicated parking lot 2 for parking the shared vehicle 1 is the location where the shared vehicle 1 is rented and returned, and when the user uses the shared vehicle 1, for example, the same parking lot (parking spaces) is the renting location and returning location of the shared vehicle 1. The car sharing service differs from a car rental service in this respect in which a vehicle can be returned to a location different from the renting location (e.g., a store in the same series). Similar to the shared vehicle 1, the dedicated parking lot 2 is a parking lot of which necessary information is registered in advance in a business entity for conducting car sharing business, and the registered information is stored in the server apparatus 50 (a parking lot database 532 to be described later).

FIG. 3 is a block diagram showing a configuration of a main component of the car sharing system 100 shown in FIG. 1. As shown in FIG. 3, the on-vehicle terminal 10, the parking lot cameras 20, the user terminal 30, the manager terminal 40 and the server apparatus 50 are coupled to a communication network 60, such as a wireless communication network, an Internet network, or a telephone line network. Although single on-vehicle terminal 10, single parking lot cameras 20, single user terminal 30 and single manager terminal 40 are shown in FIG. 3 for convenience, a plurality of the on-vehicle terminals 10, the parking lot cameras 20, the user terminals 30 and the manager terminals 40 may be connected to the communication network 60.

The on-vehicle terminal 10 includes, for example, an on-vehicle navigation apparatus. As shown in FIG. 3, the on-vehicle terminal 10 includes a communication unit 11, an input-output unit 12, a memory unit 13, and a processing unit 14. An on-vehicle camera 15, a sensor group 16 and actuator 17 connected to the on-vehicle terminal 10.

The communication unit 11 is configured to be able to communicate with the server apparatus 50 via a communication network 60 by wireless communication. The input-output unit 12 is a generic term for a device for inputting and outputting various commands and various data, and includes various switches, buttons, microphones, speakers, monitors, and the like that can be operated by the user. In addition, the input-output unit 12 has a card reader 121 for reading user information from an authentication card owned by the user. For example, a driver's license (IC card license) in which an integrated circuit (IC) storing personal data of the user is incorporated is used as authentication card. The card reader 121 is provided at a predetermined portion of vehicle 1, for example, below the rear window, so that the authentication card approached from the outside of the vehicle 1 can be recognized.

The memory unit 13 has a volatile or nonvolatile memory (not shown). The memory unit 13 stores various programs and various data executed by the processing unit 14. For example, programs and map data related to the navigation function, image data obtained by the on-vehicle camera 15, detection data detected by the sensor group 16, and the like are temporarily stored.

The processing unit 14 has a microprocessor, executes predetermined processing based on a signal inputted via the input-output unit 12, image data obtained by the on-vehicle camera 15 (hereinafter, referred to as a vehicle-interior image data), a signal detected by the sensor group 16, a signal received from the outside of the on-vehicle terminal 10 via the communication unit 11, programs and data stored in the memory unit 13 and the like, and outputs control signals to the actuator 17, the input-output unit 12, the memory unit 13 and the communication unit 11.

The processing unit 14 outputs a control signal to the communication unit 11 and controls transmission and reception of a signal between the on-vehicle terminal 10 and the server apparatus 50. For example, the processing unit 14, when the user brings the IC card (authentication card) previously registered close to the card reader 121 at the beginning of using the car sharing service, outputs a transmission command of the user information read by the card reader 121 to the communication unit 11. The communication unit 11 transmits the user information to the server apparatus 50 in accordance with the transmission command. The server apparatus 50 determines the presence or absence of a vehicle reservation information and the like corresponding to the received user information. Specifically, the server apparatus 50 determines whether or not the corresponding vehicle reservation information or the like is stored in a database (a vehicle database 531 to be described later). The server apparatus 50 sends an unlock command to the on-vehicle terminal 10 (the processing unit 14) if the corresponding vehicle reservation information and the like are stored in the database. If there are no corresponding vehicle reservation information and the like in the database, sends a lock command. The processing unit 14 outputs an unlock signal when receiving the unlock command and outputs a lock signal when receiving the lock command to a lock actuator 171 to be described later respectively.

The on-vehicle camera 15 is a camera (imaging apparatus) having an imaging device such as a CCD or CMOS, it is possible to image the interior of the vehicle of the shared vehicle 1. The on-vehicle camera 15 is provided to be able to image the entire interior of the vehicle. For example, the on-vehicle camera 15 is provided on the ceiling portion of the shared vehicle 1, to image the entire interior of the vehicle from the ceiling portion. Incidentally, the on-vehicle camera 15 may be configured to be movable so as to be capable of imaging the entire interior of the vehicle. Further, the on-vehicle camera 15 may be provided a plurality so as to be able to image the entire interior of the vehicle.

The on-vehicle camera 15 has an imaging capability (e.g., the number of pixels) equal to or higher than a predetermined value, and is capable of capturing an image having the number of pixels (information amount) by which an object or the like left in the vehicle (passenger's seat or the like) can be identified. For example, the on-vehicle camera 15 is capable of imaging an image of 5 million pixels.

The sensor group 16 includes various sensors that detect vehicle conditions. For example, the sensor group 16 has a GPS sensor 161 for detecting the position of the shared vehicle 1 by receiving a signal from a GPS satellite, and a remaining fuel detection sensor 162 for detecting remaining amount of fuel. Although not shown, a vehicle speed sensor for detecting a vehicle speed, an acceleration sensor for detecting an acceleration acting on the shared vehicle 1, a gyro sensor for detecting an angular velocity, a mileage sensor for detecting a mileage, a remaining battery detecting sensor for detecting a remaining battery capacity, and the like are also included in the sensor group 16.

The actuator 17 drives various devices mounted on the vehicle 1 based on signals from the on-vehicle terminal 10 (processing unit 14). The actuator 17 has, as an example, the lock actuator 171 for unlocking or locking the door lock. The lock actuator 171 unlocks the door lock based on the unlock signal from the processing unit 14 and locks the door lock based on the lock signal from the processing unit 14. Although not shown, an engine driving actuator, a transmission driving actuator, an actuator for driving a braking device, a steering actuator, and the like are also included in the actuator 17.

The parking lot camera 20 has a waterproof function and is fixedly disposed on a parking lot. As shown in FIG. 3, the parking lot camera 20 includes a communication unit 21, an imaging unit 22 having an imaging device such as a CCD or a CMOS, a memory unit 23, and a processing unit 24.

The communication unit 21 is configured to be able to communicate with the server apparatus 50 via a communication network 60 by wireless communication. The memory unit 23 has a volatile or nonvolatile memory (not shown), and stores various programs executed by the processing unit 24 and various data.

The processing unit 24 has a microprocessor, executes predetermined processing based on a signal inputted from the outside of the parking lot camera 20 via the communication unit 21, programs and data stored in the memory unit 23 and the like, and outputs control signals to the communication unit 21, the imaging unit 22, and the memory unit 23. For example, the processing unit 24 outputs a control signal to the communication unit 21 and controls transmission and reception of a signal between the parking lot camera 20 and the server apparatus 50. By such processing in the processing unit 24, the processing unit 24 outputs a control signal to the imaging unit 22 and controls imaging the shared vehicle 1 parked in the dedicated parking lot 2. Image data obtained by imaging the appearance of the shared vehicle 1 (hereinafter, referred to as appearance image data) is transferred together with a parking lot ID for identifying a parking lot to the server apparatus 50 via the communication unit 21.

The user terminal 30 is configured by a personal computer operated by a user, a portable wireless terminal represented by a smartphone, or the like. As shown in FIG. 3, the user terminal 30 includes a communication unit 31, an input-output unit 32, a sensor group 33, an imaging unit 34, a memory unit 35, and a processing unit 36.

The communication unit 31 is configured to be able to communicate with the server apparatus 50 via a communication network 60 by wireless communication. The input-output unit 32 is a generic term for a device for inputting and outputting various commands and various data, and includes, for example, a keyboard, a mouse, a monitor, a touch screen and the like. The user inputs user information via the input-output unit 32. The user information includes an address, a name, a contact address, a license number, information necessary for settlement (for example, a credit card number), and the like of the user. The user information input through the input-output unit 32 is transmitted to the server apparatus 50 through the communication unit 31 by the processing unit 36, and the server apparatus 50 (reservation managing unit 541 to be described later) registers the received user information in the database (user database 533 to be described later). Thus, the user is registered as a member of the car sharing service.

The vehicle reservation information is inputted by the user via the user terminal 30 (input-output unit 32) when applying for the use of vehicle. The vehicle reservation information includes information indicating the use date and time (the use starting date and time and the use ending date and time) of the vehicle 1 and the like. The vehicle reservation information is sent to the communication unit 21 via the server apparatus 50. When receiving the vehicle reservation information from the user terminal 30, the server apparatus 50 searches for the vehicle 1 that can be reserved satisfying the usage date and time conditions. And then, the server apparatus 50 transmits the information of the searched vehicle 1 (hereinafter, referred to as vehicle information) and the information of the parking lot in which the vehicle 1 is parked (hereinafter, referred to as parking lot information).

The user terminal 30 (processing unit 36) displays a list of searched shared vehicles 1 on an input-output unit 32 based on the received vehicle information and the received parking lot information. When the user selects a desired shared vehicle 1 via the input-output unit 32 from the list of shared vehicles 1 displayed on the input-output unit 32, an appointment of the shared vehicle 1 is confirmed.

The sensor group 33 includes various sensors for detecting the condition of the user terminal 30. For example, the sensor group 33 has a GPS sensor 231 that receives signals from GPS satellites to detect the position of the user terminal 30. Although illustration is omitted, a remaining battery capacity detection sensor for detecting remaining battery capacity of the user terminal 30, a radio wave reception sensor for detecting the reception state of the radio wave, and the like are also included in the sensor group 33.

The imaging unit 34 is a camera having an imaging device such as a CCD or CMOS. The imaging unit 34 performs imaging based on an imaging command input by the user via the input-output unit 32. The imaging unit 34 has a predetermined or more imaging capability, for example, the imaging unit 34 is capable of capturing an image of 5 million pixels or more.

The memory unit 35 has a volatile or nonvolatile memory (not shown). The memory unit 35 stores various programs executed by the processing unit 36 and various types of data. For example, the memory unit 35 stores the vehicle reservation information of the car sharing service and the like.

The processing unit 36 includes a microprocessor, executes predetermined processing based on a signal input via the input-output unit 32, a signal received from the outside of the user terminal 30 via the communication unit 31, the positional data of the user terminal 30 input via the sensor group 33, programs and data stored in the memory unit 35, and the like, and outputs control signals to the communication unit 31, the input-output unit 32, and the memory unit 35, respectively.

The processing unit 36 outputs a control signal to the communication unit 31 and controls transmission and reception of a signal between the user terminal 30 and the server apparatus 50. For example, the processing unit 36 transmits, to the server apparatus 50 via the communication unit 31, signals for instructing reservation application, reservation cancellation, and the like of the vehicle 1, and the positional data of the user terminal 30 detected by the GPS sensor 331, together with the user ID for identifying the user. By this process in processing unit 36, the user can change or confirm the reserved vehicle via the input-output unit 32 (monitor, etc.).

When the user operates the input-output unit 32 to image the shared vehicle 1 at the time of renting or returning the shared vehicle 1, the processing unit 36 transmits the image data obtained by the imaging to the server apparatus 50 via the communication unit 31 together with the user ID. That is, when the user uses the user terminal 30 to image the interior and appearance of the shared vehicle 1, data on an image of the interior (vehicle-interior image data) and data on an image of the appearance (appearance image data) can be transmitted from the user terminal 30 to the server apparatus 50.

The manager terminal 40 is configured by a personal computer operated by the manager, a portable wireless terminal represented by a smartphone, or the like. As shown in FIG. 3, the manager terminal 40 includes a communication unit 41, an input-output unit 42, a memory unit 43, and a processing unit 44.

The communication unit 41 is configured to be able to communicate with the server apparatus 50 via a communication network 60 by wireless communication. The input-output unit 42 includes, for example, a keyboard, a mouse, a monitor, a touch screen and the like.

The memory unit 43 has a volatile or nonvolatile memory (not shown), and stores various programs executed by the processing unit 44 and various data.

The processing unit 44 has a microprocessor, executes predetermined processing based on a signal inputted via the input-output unit 42, a signal received from the outside of the manager terminal 40 via the communication unit 41, programs and data stored in the memory unit 43 and the like, and outputs control signals to the communication unit 41, the input-output unit 42, and the memory unit 43, respectively. For example, the processing unit 44 outputs a control signal to the communication unit 41 and controls transmission and reception of a signal between the manager terminal 40 and the server apparatus 50.

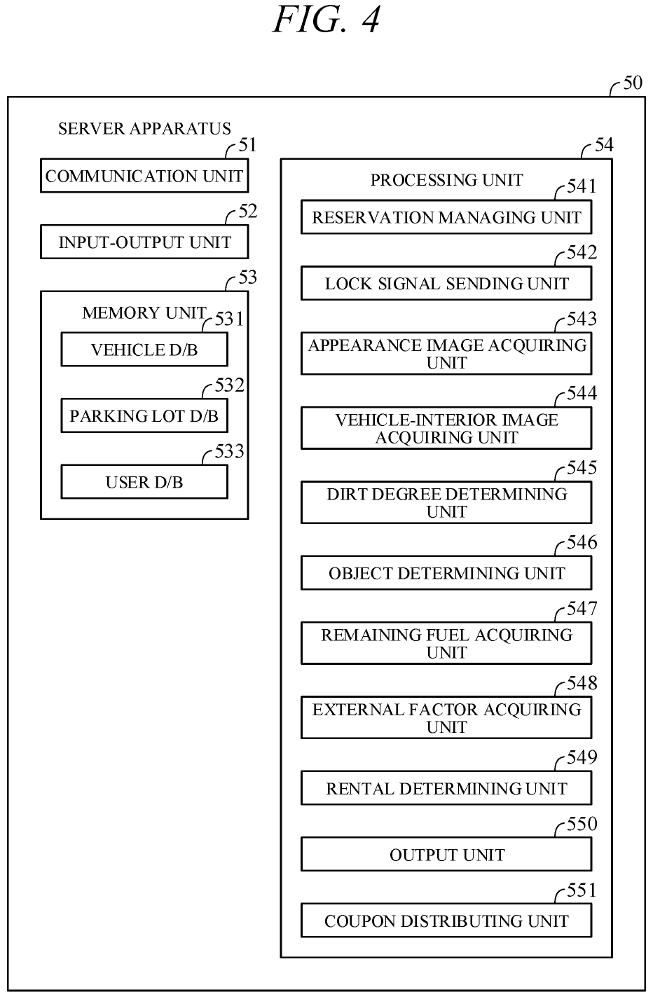

The server apparatus 50 is provided in a car sharing business entity. The server apparatus 50 can also be configured on cloud computing using a virtual server function. As shown in FIG. 4, the server apparatus 50 includes a communication unit 51, an input-output unit 52, a memory unit 53, and a processing unit 54.

The communication unit 51 is configured to be able to communicate with the on-vehicle terminal 10, the parking lot camera 20, the user terminal 30 and the manager terminal 40 via a communication network 60 by wireless communication. The input-output unit 52 is a generic term for a device for inputting and outputting various commands and various data, and includes, for example, a keyboard, a mouse, a monitor, a touch screen and the like.

The memory unit 53 has a volatile or nonvolatile memory (not shown). The memory unit 53 stores various programs and various data executed by processing unit 54. The memory unit 53 includes a vehicle database (vehicle D/B) 531, a parking lot database (parking lot D/B) 532, and a user database (user D/B) 533 as the functional constituents of the memories.

The vehicle database 531 stores vehicle information of each of a plurality of shared vehicle 1 used for the car sharing service, that is, information representing vehicle states and vehicle characteristics such as a vehicle type, a model year, a vehicle body number, a vehicle number, a mileage, a maintenance history, an operation rate, and the like of each shared vehicle 1, usage plans of each shared vehicle 1, vehicle-interior image data and appearance image data of each shared vehicle 1 and together with the vehicle ID of each shared vehicle 1. The usage plan includes the time series usage records of each shared vehicle 1, the time series vehicle reservation information of the present and future (the use starting date and time and the use ending date and time, etc.), and a maintenance plan executed between reservations of the vehicle 1. The vehicle-interior image data and appearance image data include images of the appearance obtained by imaging the shared vehicle 1 from four sides (e.g., right front, left front, right rear, left rear) and images of the interior obtained by imaging from the ceiling portion of the shared vehicle 1.

The parking lot database 532 stores, together with a parking lot ID, parking lot information of the dedicated parking lot 2 in which the shared vehicle 1 used for the car sharing service is to be parked, specifically, the address of each dedicated parking lot 2, the position of a parking space in each dedicated parking lot 2, and the vehicle ID of the shared vehicle 1 parked in the parking space.

The user database 333 stores, together with the user ID, user information including the address, name, contact address, license number, and information necessary for settlement of each user and information on the availability to rent the shared vehicle 1 next time to each user input through the user terminal 30 (input-output unit 32).

The processing unit 54 includes a microprocessor. The processing unit 54 executes predetermined processes based on a signal received from the outside of the server apparatus 50 via the communication unit 51, a signal inputted via the input-output unit 52, and programs, data and the like stored in the memory unit 53, and outputs control signals to the communication unit 51, the input-output unit 52 and the memory unit 53.

The processing unit 54 includes a reservation managing unit 541, a lock signal transmitting unit 542, an appearance image acquiring unit 543, a vehicle-interior image acquiring unit 544, a degree-of-dirt determining unit 545, an object determining unit 546, a remaining fuel acquiring unit 547, an external factor acquiring unit 548, a rental determining unit 549, an output unit 550, and a coupon distributing unit 551, as functional configurations of the processor.

The reservation managing unit 541 accepts usage application of the vehicle 1 from the user via the user terminal 30 (input-output unit 32). Specifically, the reservation managing unit 541 receives vehicle reservation information input by the user via the input-output unit 32 from user terminal 30 via communication unit 51. The reservation managing unit 541 searches for the vehicle 1 that can be reserved, that is, the vehicle 1 that meets the condition of the use date and time specified in the received vehicle reservation information. The reservation managing unit 541 transmits information of the searched shared vehicle 1 to the user terminal 30. The user terminal 30 displays a list of the searched shared vehicle 1 on the input-output unit 32 based on the received information of the shared vehicle 1. When the user selects the desired vehicle 1 from the list displayed on the input-output unit 32, the selected vehicle 1 is confirmed as the reservation vehicle.

The reservation managing unit 541 generates current and future usage plans for each vehicle 1 and registers the generated usage plans in the vehicle database 531. Specifically, the reservation managing unit 541 updates the use plan of the reservation vehicle for which the reservation is confirmed and registers the updated use plan in the vehicle database 531.

When receiving the user information read by the card reader 121 from the on-vehicle terminal 10, the lock signal transmitting unit 542 determines whether or not there is a vehicle reservation information and the like corresponding to the user information, and transmits an unlock signal to the on-vehicle terminal 10 through the communication unit 31 if there is a corresponding vehicle reservation information, and transmits a lock signal if there is no corresponding vehicle reservation information.

The appearance image acquiring unit 543 acquires appearance image data at the time of renting and returning the shared vehicle 1. Specifically, the appearance image acquiring unit 543 receives the appearance image data of the shared vehicle 1 transmitted from parking lot camera 20 through the communication unit 51. The appearance image acquiring unit 543 receives the appearance image data obtained by capturing an image of the shared vehicle 1 by the imaging unit 34 from the user terminal 30 via the communication unit 51. Hereinafter, “acquiring image information” or the like may be simply referred to as “acquiring an image” or the like.

The vehicle-interior image acquiring unit 544 acquires the vehicle-interior image data at the time of renting and returning the shared vehicle 1. Specifically, the vehicle-interior image acquiring unit 544 acquires, from the on-vehicle terminal 10 via the communication unit 51, the vehicle-interior image data obtained by imaging the shared vehicle 1 by the on-vehicle camera 15. In addition, the vehicle-interior image acquiring unit 544 receives, from the user terminal 30 via the communication unit 51, the vehicle-interior image data obtained by imaging the shared vehicle 1 by the imaging unit 34.

The dirt degree determining unit 545 determines the dirt degree of the shared vehicle 1 based on the appearance image data acquired by the vehicle-interior image acquiring unit 543 and the vehicle-interior image data acquired by the vehicle-interior image acquiring unit 544. More specifically, the dirt degree determining unit 545 compares the appearance image data obtained by the appearance image acquiring unit 543 at the time of renting and returning the shared vehicle 1 to determine the dirt degree of the appearance of the shared vehicle 1. For example, the dirt degree determining unit 545 compares the appearance image at the time of renting and the appearance image at the time of returning, and detects scratches, dirt, and the like that exist at the time of returning the shared vehicle 1 and do not exists at the time of renting the shared vehicle 1. Scratches, dirt and the like at the time of returning the shared vehicle 1 can be detected by using a common image-processing technique. For example, scratches, dirt, and the like at the time of returning the shared vehicle 1 can be detected based on the calculated difference by calculating the difference between the appearance image at the time of renting and the appearance image at the time of returning. More specifically, the dirt degree determining unit 545 calculates the difference between the pixel values of the appearance image at the time of renting and the appearance image at the time of returning for each pixel position, and calculates a proportion D1 of pixels in which the difference of the pixel values is equal to or greater than a predetermined value to the entire image (the total number of pixels). Then, the dirt degree determining unit 545 detects scratches, dirt, and the like when the shared vehicle 1 is returned, based on the calculated proportion D1.

The dirt degree determining unit 545 determines that the lower the calculated proportion D1, that is, the smaller the change between the two appearance images, the lower the dirt degree of the appearance. For example, when the calculated proportion D1 is 10% or less, it is determined that the appearance is not dirty, when it is 11% or more and 30% or less, it is determined that the appearance is slightly dirty but clean, when it is 31% or more and 50% or less, it is determined that the appearance is dirty, and when it is 51% or more, it is determined that the appearance is quite dirty.

Similarly, the dirt degree determining unit 545 compares the vehicle-interior images at the time of renting and returning the shared vehicle 1 acquired by the vehicle-interior image acquiring unit 544 to determine the degree of dirt of the interior of the shared vehicle 1. For example, the dirt degree determining unit 545 compares the vehicle-interior image at the time of renting with the vehicle-interior image at the time of returning to detect scratches, dirt, and the like. at the time of returning of the shared vehicle 1 that was do not existed at the time of renting. The method of detecting the degree of scratches, dirt, and the like of the interior of the shared vehicle 1 when the shared vehicle 1 is returned is the same as the method of detecting scratches, dirt, and the like of the appearance of the shared vehicle 1. Specifically, the dirt degree determining unit 545 calculates the difference between the pixel values of the vehicle-interior image at the time of renting and the vehicle-interior image at the time of returning for each pixel position, and calculates a proportion D2 of pixels in which the difference of the pixel values is equal to or greater than a predetermined value to the entire image (the total number of pixels). Then, the dirt degree determining unit 545 detects scratches, dirt, and the like of the interior of the shared vehicle 1 when the shared vehicle 1 is returned, based on the calculated proportion D2.

The dirt degree determining unit 545 determines that the lower the calculated proportion D2, that is, the smaller the change between the two appearance images, the lower the degree of dirt of the interior of the vehicle. For example, when the calculated proportion D2 is 10% or less, it is determined that the interior of the vehicle is not dirty, when it is 11% or more and 30% or less, it is determined that the interior of the vehicle is slightly dirty but clean, when it is 31% or more and 50% or less, it is determined that the interior of the vehicle is dirty, and when it is 51% or more, it is determined that the interior of the vehicle is quite dirty.

The object determining unit 546 determines the presence or absence of the object left in the shared vehicle 1 by the user who has used the vehicle based on the vehicle-interior image data acquired by the vehicle-interior image acquiring unit 544. In the present embodiment, the object determining unit 546 compares the vehicle-interior image at the time of renting the shared vehicle 1 and the vehicle-interior image at the time of returning the shared vehicle 1, which are acquired by the vehicle-interior image acquiring unit 544, to determine whether there is an object left in the vehicle of the shared vehicle 1 by the user. For example, the object determining unit 546 compares the vehicle-interior image at the time of renting with the vehicle-interior image at the time of returning to detect an object that does not exist at the time of renting the shared vehicle 1 and exists at the time of returning the shared vehicle 1. An object can be detected from a vehicle-interior image using an object recognition technique using general image processing.

The remaining fuel acquiring unit 547 acquires remaining fuel information at the time of returning the shared vehicle 1. The remaining fuel acquiring unit 547 receives, via the communication unit 51, information of the remaining fuel detected by the remaining fuel detection sensor 162 of sensor group 16 connected to the on-vehicle terminal 10 mounted on the shared vehicle 1.

The external factor acquiring unit 548 acquires information about external factors (hereinafter, referred to as external factor information) for dirtying the shared vehicle 1. For example, if the user goes to the ocean or mountain, the shared vehicle 1 is likely to become dirty when snow or rain falls. Therefore, the external factor acquiring unit 548 receives, via the communication unit 51, the traveling information (the traveling locus) of the shared vehicle 1 detected by the GPS sensor 161 of the on-vehicle terminal 10 and the weather information distributed from an external server (not shown).

The rental determining unit 549 determines whether or not the next renting to the user of the shared vehicle 1 is permitted based on the degree of dirt determined by the dirt degree determining unit 545, the presence or absence of the object determined by the object determining unit 546, the remaining fuel information acquired by the remaining fuel acquiring unit 547, and the external factor information acquired by the external factor acquiring unit 548.

Incidentally, in the car sharing service, a vehicle is rented without human intervention, and the inside and outside of the vehicle are inspected by the user at the time of returning. On the other hand, in the car sharing service, it is desired that the shared vehicle 1 be clean at the time of renting and fuels are sufficiently replenished so that all users who use the car sharing service can comfortably use a vehicle. Therefore, the rental determining unit 549 determines whether or not the next renting of the shared vehicle 1 is permitted based on the dirt degree and the remaining fuels of the shared vehicle 1 at the time of returning as described above. The rental determining unit 549 stores information of the result of determination of the next renting of the shared vehicle 1 in the user database 533.

For example, when the proportions D1 and D2 are 40% or less, the remaining fuel is 50% or more, and there are no objects left by the user, the rental determining unit 549 permits the next renting to the user who used the shared vehicle 1. On the other hand, in other cases, the rental determining unit 549 does not permit the next renting to the user who used the shared vehicle 1.

The rental determining unit 549 may permit the next renting to the user who used the shared vehicle 1 when the above-mentioned proportions D1 and D2 are 50% or less (slightly dirty but clean), the remaining fuel is 30% or more (⅓ or more), and there are no objects left by the user. Further, when the proportions D1 and D2 are 40% or less and the remaining fuels are 50% or more, a discount coupon may be distributed to the user who used the shared vehicle 1.

In addition, the rental determining unit 549 performs a process of reducing the above-described proportions D1 and D2 calculated by the dirt degree determining unit 545 based on the information acquired by the external factor acquiring unit 548. For example, when the external factor acquiring unit 548 acquires rainfall forecast information as external factor information, the rental determining unit 549 performs a process of subtracting 5 from the above-described proportions D1 and D2 calculated by the dirt degree determining unit 545. For example, when the external factor acquiring unit 548 acquires rainfall forecast information and the above-mentioned proportions D1 and D2 are 55%, the rental determining unit 549 determines whether the next renting is permitted or not by setting the proportions D1 and D2 to 50(=55−5)%.

The output unit 550 transmits, to the manager terminal 40 via the communication unit 51, information on the degree of dirt determined by the dirt degree determining unit 545 and information on the presence or absence of an object left by the user determined by the object determining unit 546. As a result, the manager of the shared vehicle 1 can grasp the degree of dirt of the shared vehicle 1, and can request washing or the like of the shared vehicle 1 based on the degree of dirt. That is, it is possible to efficiently request washing of the shared vehicle 1. Further, the manager of the shared vehicle 1 can grasp the object left in the shared vehicle 1 by the user who used the shared vehicle 1 without going to check the shared vehicle 1, and for example, can promptly respond to the inquiry of the object left in the shared vehicle 1 by the user from the user.

The output unit 550 transmits the information on the presence or absence of an object determined by the object determining unit 546 to the user terminal 30 via the communication unit 51. This allows the user to easily know that he or she has left an object in the shared vehicle 1, and to go to take the object when he or she is near the shared vehicle 1. In this case, the user can take out the object from the interior of the shared vehicle 1 by contacting the manager and having a one-time key issue to himself or herself.

Further, the output unit 550 transmits the information indicating whether or not the next renting to the user of the shared vehicle 1 determined by the rental determining unit 549 is permitted, that is, the result of the determination by the rental determining unit 549 to the manager terminal 40 via the communication unit 51. As a result, the manager of the shared vehicle 1 can grasp use manners of the user based on whether or not the next renting to the user of the shared vehicle 1 is permitted. The output unit 550 may transmit the result of the determination by the rental determining unit 549 to the user terminal 30 via the communication unit 51. This allows the user to improve his or her own use manners.

The coupon distributing unit 551 distributes an electronic coupon (discount coupon) by which usage fee of the car sharing service is discounted to the user when the appearance image acquiring unit 543 acquires the appearance image data obtained by capturing the shared vehicle 1 by the user using the car sharing service. Specifically, when the appearance image acquiring unit 543 acquires the appearance image data from the user terminal 30, the coupon distributing unit 551 issues the discount coupon and transmits the discount coupon to the user terminal 30 via the communication unit 51.

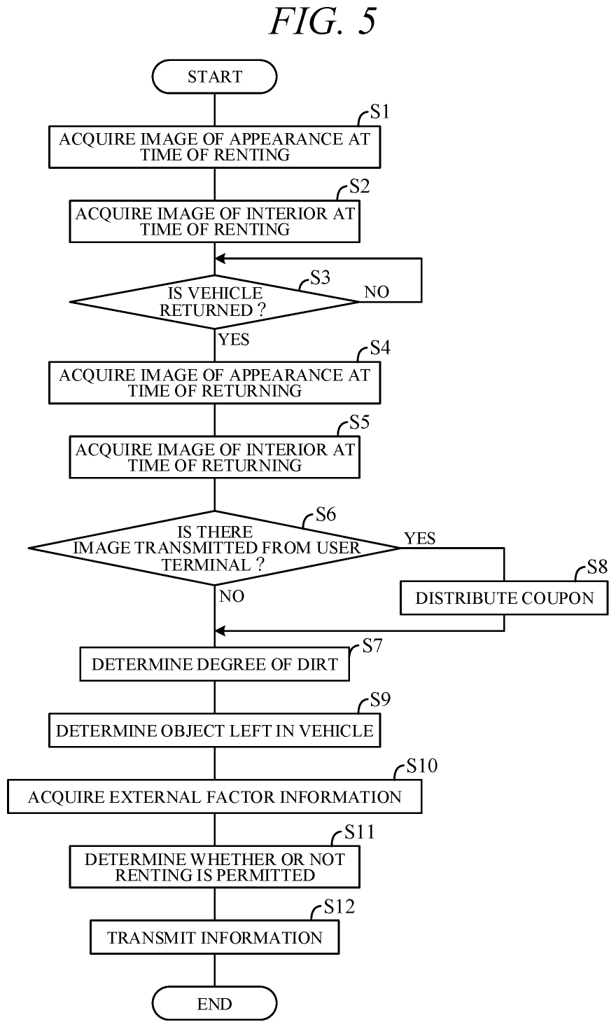

FIG. 5 is a flow chart showing an example of a vehicle status notification process executed by processing unit 54 of the server apparatus 50 of FIG. 3. The process shown in the flow chart is started when the use of the car sharing service is started.

When an unlock signal is transmitted to the on-vehicle terminal 10 of the shared vehicle 1 via the communication unit 51 by processing in the lock signal transmitting unit 542, first, in step S1 (S: processing Step), by the process in the appearance image acquiring unit 543, the appearance image of the shared vehicle 1 at the time of renting captured by the parking lot cameras 20 of the dedicated parking lot 2 is acquired. Then, in S2, by the process in the vehicle-interior image acquiring unit 544, the vehicle-interior image of the shared vehicle 1 at the time of renting captured by the on-vehicle camera 15 connected to on-vehicle terminal 10 of the shared vehicle 1 is acquired.

Next, in S3, by the process in the lock signal transmitting unit 542, it is determined whether or not the shared vehicle 1 is returned to the dedicated parking lot 2. S3 is repeated until the result is YES. When the use of the car sharing service is finished, the user information read by the card reader 121 is transmitted to the server apparatus 50 when the user moves the authentication card closer to the card reader 121. Upon receiving the user information via the communication unit 51, the lock signal transmitting unit 542 specifies the position at which the user information is transmitted. The lock signal transmitting unit 542 determines that the shared vehicle 1 is returned to the dedicated parking lot 2 when the position at which the user information is transmitted is the dedicated parking lot 2. The transmitting position of the user information can be detected based on the traveling information (position information) of the shared vehicle 1 transmitted from the on-vehicle terminal 10. When determining that the shared vehicle 1 is returned to the dedicated parking lot 2, the lock signal transmitting unit 542 transmits a lock signal to the shared vehicle 1 (on-vehicle terminal 10) via the communication unit 51.

When the result in S3 is YES, in S4, by the process in the appearance image acquiring unit 543, the appearance image of the shared vehicle 1 at the time of returning captured by parking lot camera 20 of the dedicated parking lot 2 is acquired via the communication unit 51.

Then, in S5, by the process in the vehicle-interior image acquiring unit 544, the vehicle-interior image of the shared vehicle 1 at the time of returning captured by the on-vehicle camera 15 connected to on-vehicle terminal 10 of the shared vehicle 1 is acquired. Next, in S6, by the process in the vehicle-interior image acquiring unit 544, it is determined whether or not the external image or the internal image of the shared vehicle 1 at the time of returning, which is captured by the user terminal 30, is acquired. Specifically, it is determined whether or not the appearance image data or the vehicle-interior image data of the shared vehicle 1 at the time of returning transmitted from the user terminal 30 is received via the communication unit 51. For example, the user operates the user terminal 30 to image the appearance and the internal of the shared vehicle 1 when the use of the car sharing service is finished. Then, the user inputs a transmission command of the appearance image data and the vehicle-interior image data obtained by imaging to the user terminal 30 via the input-output unit 32. Thus, the appearance image data and the vehicle-interior image data are transmitted from the user terminal 30 to the server apparatus 50.

When the result in S6 is NO, in S7, by the process in the dirt degree determining unit 545, the degree of dirt of the shared vehicle 1 is determined. On the other hand, when the result in S6 is YES, the process proceeds to S8. In S8, by the process of the coupon distributing unit 551, the discount coupon is distributed to the user terminal 30, and then, the process proceeds to S7.

Next, in S9, by the processing in the object determining unit 546, the presence or absence of an object left in the shared vehicle 1 by the user is determined. Next, in S10, by the processing in the external factor acquiring unit 548, an external factor information is acquired. Next, in S11, by the processing in the rental determining unit 549, it is determined whether or not the next renting to the user is permitted.

Next, in S12, by the processing in the output unit 550, the information on the degree of dirt of the shared vehicle 1 (hereinafter referred to as dirty information), the information on the presence or absence of an object left in the shared vehicle 1 by the user (hereinafter referred to as object information), and the result of the determination of whether or not the next renting of the shared vehicle 1 is permitted are transmitted to the manager terminal 40 and the user terminal 30, and the processing is terminated.

The object information and the result of the determination of whether or not the next renting of the shared vehicle 1 is permitted, which are transmitted to the user terminal 30 in S12, and the discount coupon transmitted to the user terminal 30 in S8 are displayed on the input-output unit 32 (touch panel) by the processing unit 36. In addition, the processing unit 36 may display the vehicle-interior images showing the object left in the shared vehicle 1 by the user on the input-output unit 32 in accordance with operations of the user. At this time, when the user performs a predetermined operation on the input-output unit 32, the user terminal 30 may be able to communicate with the manager terminal 40. Further, the processing unit 36 may display the discount content of the discount coupon on the input-output unit 32 in response to operations of the user.

Similarly, the dirty information, the object information, and the result of the determination of whether or not the next renting of the shared vehicle 1 is permitted, which are transmitted to the manager terminal 40 in S12, are displayed on the input-output unit 42 (touch panel) by the processing unit 44. At this time, when the manager performs predetermined operations on the input-output unit 42, the processing unit 44 may display the vehicle-interior images showing the object left in the shared vehicle 1 by the user on the input-output unit 42. The processing unit 44 may be capable of communicating with the user terminal 30 when the manager performs predetermined operations on the input-output unit 42. The processing unit 44 may display the external image and the vehicle-interior image of the shared vehicle 1 together with the degree of dirt on the input-output unit 42 when the manager performs predetermined operations on the input-output unit 42.

The present embodiment can achieve advantages and effects such as the following:

(1) The server apparatus 50 includes the appearance image acquiring unit 543 for acquiring data on an appearance image of the shared vehicle 1 used in a car sharing service in which a vehicle is rented without human intervention when the shared vehicle 1 is returned, the vehicle-interior image acquiring unit 544 for acquiring data on a vehicle-interior image of the shared vehicle 1 when the shared vehicle 1 is returned, the dirt degree determining unit 545 for determining the degree of dirt of the shared vehicle 1 based on the data on the appearance image acquired by the appearance image acquiring unit 543 and the data on the vehicle-interior image acquired by the vehicle-interior image acquiring unit 544, the object determining unit 546 determining the presence or absence of an object left in the shared vehicle 1 by the user based on the data on the vehicle-interior image acquired by the vehicle-interior image acquiring unit 544, and the output unit 550 transmitting information on a result of the determination of the degree of dirt by the dirt degree determining unit 545 and information on a result of the determination of the presence or absence of the object by the object determining unit 546 to the manager terminal 40 of the manager of the shared vehicle 1.

With this configuration, since the status and the like of the shared vehicle 1 are notified to the manager terminal 40, an efficient response can be achieved, and the shared vehicle 1 can be used comfortably by the user without increasing costs. For example, since the status or the like of the shared vehicle 1 is notified to the manager terminal 40, the manager of vehicle can be efficiently dispatched to the shared vehicle 1. Therefore, the number of personnel dispatches can be reduced, and the cost can be reduced.

Further, for example, since the status or the like of the shared vehicle 1 is notified to the manager terminal 40, the manager of the shared vehicle 1 only need to perform the cleaning of the shared vehicle 1 when receiving the notification that the shared vehicle 1 is dirty, so that the number of times of cleaning can be reduced and costs can be reduced. As a result, a well-cleaned shared vehicle can be comfortably used by the user without increasing costs.

Further, for example, since the information about the object left in the shared vehicle 1 by the user is notified, the manager of the shared vehicle 1 can grasp the object left in the shared vehicle 1 by the user who used the shared vehicle 1 without going to check the shared vehicle 1, and can promptly respond to the inquiry of the object from the user, and for example, can promptly respond to the inquiry of the object left in the shared vehicle 1 by the user from the user. The user can easily know that he or she has left an object in the shared vehicle 1, and go to take the object when he or she is near the shared vehicle 1.

(2) The server apparatus 50 further includes the remaining fuel acquiring unit 547 for acquiring data on remaining fuel quantity of the shared vehicle 1 when the shared vehicle 1 is returned, and the rental determining unit 549 for determining whether or not to rent the shared vehicle 1 to the user of the shared vehicle 1 next time based on the degree of dirt determined by the dirt degree determining unit 545, the result of the determination of the presence or absence of the object by the object determining unit 546, and the information on remaining fuel acquired by the remaining fuel acquiring unit 547. Thereby, the manager of the shared vehicle 1 can grasp usage manners of the user, and the user can improve the his or her own usage manners.

(3) The rental determining unit 549 stores information of the result of determining whether or not to rent the shared vehicle 1 to the user next time in the user database 533 together with the user ID being capable of identifying the user. As a result, the manager of the shared vehicle 1 can easily grasp the manners used by each user.

(4) The output unit 550 transmits information of the result of the determination by the rental determining unit 549 to at least one of the manager terminal 40 and the user terminal 30 of the user who used the shared vehicle 1. As a result, the manager of the shared vehicle 1 can grasp the manners used by the user. Users will try to improve their own manner of use.

(5) The appearance image acquiring unit 543 acquires data on the appearance image of the shared vehicle captured by the parking lot camera 20 disposed in the unmanned dedicated parking lot 2 where the shared vehicle 1 is rented and returned. As a result, it is possible to easily acquire the external images of the shared vehicle 1 at the time of return.

(6) The server apparatus 50 further includes the coupon distributing unit 551 that distributes an electronic coupon for which usage fee of the car sharing service is discounted to the user terminal 30 when the appearance image acquiring unit 543 acquires the data on the appearance image of the shared vehicle 1 captured by the imaging unit 34 mounted on the user terminal 30 of the user using car sharing service. This can promote the use of car sharing service.

(7) The car sharing system 100 includes the above-mentioned server apparatus 50, the manager terminal 40 which is used a manager who manages the shared vehicle 1 and which can communicate with the server apparatus 50, the user terminal 30 which is used by a user using car sharing service and which can communicate with server apparatus 50, and the shared vehicle 1 on which the on-vehicle terminal 10 which can communicate with server apparatus 50 is mounted. With this configuration, since the status and the like of the shared vehicle 1 are notified to the manager terminal 40, an efficient response can be achieved, and the shared vehicle 1 can be used comfortably by the user without increasing costs. For example, since the status or the like of the shared vehicle 1 is notified to the manager terminal 40, the manager of vehicle can be efficiently dispatched to the shared vehicle 1. Therefore, for example, the number of times of dispatching personnel can be reduced, and the cost can be reduced.

(8) The information notification apparatus according to the above embodiment can also be configured as an information notification method. The information notification method includes steps of acquiring a first data on an image of an appearance of the shared vehicle 1 used in the car sharing service in which a vehicle is rented without human intervention, when the shared vehicle 1 is returned, acquiring a second data on a vehicle-interior image of the shared vehicle 1 when the shared vehicle 1 is returned, determining the degree of dirt of the shared vehicle 1 based on the first data and the second data, determining the presence or absence of an object left in the shared vehicle 1 by the user of the shared vehicle 1 based on the second data; and transmitting information on the degree of dirt and information on the presence or absence of the object to the manager terminal 40 of the manager of the shared vehicle 1. With this, since the status and the like of the shared vehicle 1 are notified to the manager terminal 40, an efficient response can be achieved, and the shared vehicle 1 can be used comfortably by the user without increasing costs.

In the above embodiment, the appearance image acquiring unit 543 acquires the appearance image data at the time of both renting and returning the shared vehicle 1, but the appearance image acquiring unit 543 may be configured to acquire at least the appearance image data at the time of renting the shared vehicle 1.

In the above embodiment, the vehicle-interior image acquiring unit 544 acquires the appearance image data at the time of both renting and returning the shared vehicle 1. However, the vehicle-interior image acquiring unit 544 may be configured to acquire at least the appearance vehicle-interior image data at the time of renting the shared vehicle 1.

In the above embodiment, the dirt degree determining unit 545 compares the appearance image at the time of renting and the appearance image at the time of returning, which are acquired by the appearance image acquiring unit 543, to determine the degree of dirt of appearance of the shared vehicle 1, but the present invention is not limited thereto. For example, the dirt degree determining unit 545 may be configured to compare the appearance image captured in advance and the appearance image acquired by the appearance image acquiring unit 543 at the time of returning the shared vehicle 1 to determine the degree of dirt of appearance of the shared vehicle 1.

Similarly, in the above embodiment, the dirt degree determining unit 545 compares the vehicle-interior image at the time of renting and the vehicle-interior image at the time of returning, which are acquired by the vehicle-interior image acquiring unit 544, to determine the degree of dirt of the interior of the shared vehicle 1, but the present invention is not limited thereto. For example, the dirt degree determining unit 545 may be configured to compare the vehicle-interior image captured in advance and the vehicle-interior image acquired by the vehicle-interior image acquiring unit 544 at the time of returning the shared vehicle 1 to determine the degree of dirt of the interior of the shared vehicle 1.

In the above embodiment, the object determining unit 546 compares the vehicle-interior image at the time of renting the shared vehicle land the vehicle-interior image at the time of returning the shared vehicle 1, which are acquired by the vehicle-interior image acquiring unit 544, to determine whether there is an object left in the vehicle of the shared vehicle 1 by the user, but the present invention is not limited thereto. For example, the object determining unit 546 may be configured to compare the vehicle-interior image captured in advance with the vehicle-interior image at the time of returning which is acquired by the vehicle-interior image acquiring unit 544 to determine whether there is an object left in the vehicle of the shared vehicle 1 by the user.

In the above embodiment, the rental determining unit 549 determines whether or not the next renting to the user of the shared vehicle 1 is permitted based on the degree of dirt determined by the dirt degree determining unit 545, the presence or absence of the object left in the shared vehicle1 determined by the object determining unit 546, the remaining fuel information acquired by the remaining fuel acquiring unit 547, and the external factor information acquired by the external factor acquiring unit 548, but the present invention is not limited thereto. For example, the rental determining unit 549 may be configured to determine whether or not the next renting to the user of the shared vehicle 1 is permitted based on the degree of dirt determined by the dirt degree determining unit 545, the presence or absence of the object left in the shared vehicle1 determined by the object determining unit 546, and the remaining fuel information acquired by the remaining fuel acquiring unit 547.

Above, while the present invention has been described with reference to the preferred embodiments thereof, it will be understood, by those skilled in the art, that various changes and modifications may be made thereto without departing from the scope of the appended claims.

What is claimed is:

1. An information notification apparatus comprising:
a microprocessor and a memory coupled to the microprocessor, wherein
the microprocessor and the memory are configured to perform
acquiring a first data on an image of an appearance of a shared vehicle used in a car sharing service in which a vehicle is rented without human intervention, when the shared vehicle is returned,
acquiring a second data on an image of an interior of the shared vehicle when the shared vehicle is returned,
determining a degree of dirt of the shared vehicle based on the first data and the second data,
determining a presence or absence of an object left in the shared vehicle by a user of the shared vehicle based on the second data; and
transmitting an information on the degree of dirt and an information on the presence or absence of the object to a manager terminal of a manager of the shared vehicle.

2. The information notification apparatus according to claim 1, wherein
the microprocessor and the memory are configured to further perform
acquiring a third data on a remaining fuel quantity of the shared vehicle when the shared vehicle is returned, and
determining whether or not to rent the shared vehicle to the user next time based on the degree of dirt, the presence or absence of the object, and the acquired third data.

3. The information notification apparatus according to claim 2, wherein
the microprocessor and the memory are configured to perform
the determining whether or not to rent the shared vehicle to the user next time including storing an information on a result of the determining whether or not to rent the shared vehicle to the user next time in a database together with a user ID being capable of identifying the user.

4. The information notification apparatus according to claim 2, wherein
the microprocessor and the memory are configured to perform
the transmitting including transmitting an information on a result of the determining whether or not to rent the shared vehicle to the user next time to at least one of the manager terminal and a user terminal of the user of the shared vehicle.

5. The information notification apparatus according to claim 1, wherein
the microprocessor and the memory are configured to perform
the acquiring the first data including acquiring a data on an image of the appearance of the shared vehicle captured by an imaging apparatus disposed in an unmanned parking lot where the shared vehicle is rented and returned.

6. The information notification apparatus according to claim 1, wherein
the microprocessor and the memory are configured to further perform
distributing an electronic coupon for which a usage fee of the car sharing service is discounted to a user terminal of the user of the shared vehicle when a data on the image of the appearance of the shared vehicle captured by an imaging apparatus mounted on the user terminal is acquired as the first data.

7. A car sharing system comprising
the information notification apparatus according to claim 1;
a manager terminal of a manager of a shared vehicle in a car sharing service in which a vehicle is rented without human intervention, being capable of communicating with the information notification apparatus;
a user terminal of a user of the car sharing service, being capable of communicating with the information notification apparatus; and
a vehicle on which a terminal being capable of communicating with the information notification apparatus is mounted.

8. An information notification method including:
acquiring a first data on an image of an appearance of a shared vehicle used in a car sharing service in which a vehicle is rented without human intervention, when the shared vehicle is returned,
acquiring a second data on an image of an interior of the shared vehicle when the shared vehicle is returned,
determining a degree of dirt of the shared vehicle based on the first data and the second data,
determining a presence or absence of an object left in the shared vehicle by a user of the shared vehicle based on the second data; and
transmitting an information on the degree of dirt and an information on the presence or absence of the object to a manager terminal of a manager of the shared vehicle.
